(19) United States
(12) Patent Application Publication
(10) Pub. No.: US 2017/0009696 A1
(43) Pub. Date: Jan. 12, 2017

(54) SYSTEM FOR CONTROLLING PRESSURE OF FUEL SUPPLIED TO ENGINE

(71) Applicant: Caterpillar Inc., Peoria, IL (US)

(72) Inventor: Xinyu Ge, Peoria, IL (US)

(73) Assignee: Caterpillar Inc., Peoria, IL (US)

(21) Appl. No.: 15/275,710

(22) Filed: Sep. 26, 2016

(51) Int. Cl. F02D 41/30; F02M 37/00

(52) U.S. Cl. CPC F02D 41/3082; F02M 37/0023

(57) ABSTRACT

A system for controlling pressure of fuel supplied to an engine is disclosed. The system includes a pressure sensor to generate signals indicative of pressure of fuel at an outlet of a pressure regulator. The system includes a stepper motor coupled to a gear drive. The system includes a controller, in electric communication with the pressure sensor and the stepper motor, monitors the pressure of the fuel and determines an average pressure of the fuel at the outlet of the pressure regulator for a predefined cycle. The controller compares the determined average pressure with a threshold pressure and generates an output signal when the determined average pressure is beyond the threshold pressure. The controller further communicates the output signal with the stepper motor to preload the pressure regulator and controls the pressure of the fuel at the outlet of the pressure regulator.

### TECHNICAL FIELD

The present disclosure relates to an engine, and more particularly relates to a system for controlling pressure of fuel supplied to the engine.

### BACKGROUND

Air-Fuel ratio is a critical parameter for gas engine applications. Generally, a fuel metering valve controls fuel flow rate with respect to air flow rate to maintain right quantity of air-fuel ratio. However, in order to keep the fuel metering valve operating in an optimum condition, a pressure regulator is required to control pressure of fuel supply. Typically, the pressure regulator operates at a certain pressure range. In order to address such concerns of the pressure regulator, electronically controlled pressure regulator (electronic regulator) may be used in the gas engine applications. The electronic regulator may utilize a solenoid valve to control the pressure of the fuel supply. The electronic regulator may monitor the pressure of the fuel at an outlet and adjust the valve position purely by actuating the solenoid of the electronic regulator. As such, on each adjustment of the electronic regulator by the solenoid valve, the cyclic time of the solenoid valve may hit hundreds of millions during an entire useful life. The cyclic time of the solenoid valve may increase the cost of the solenoid valve of the electronic regulator, and hence may reduce the affordability of the e-regulator for gas engine applications.

U.S. Pat. No. 4,694,811, hereinafter referred to as the '811 patent, describes an air-gas mixing device of the type used to mix air and gaseous fuel as a gaseous fuel charge for an internal combustion engine. Fuel and air valves for controlling the air fuel mixture are coupled together and actuated by a diaphragm in response to a fluid pressure signal. The fuel valve is also independently actuated by a stepper motor mounted to the diaphragm and operated by a remote electrical control signal from a controller. Because of the dual control of the fuel valve, the device is capable of handling a wide range of gaseous fuels of different BTU content and of providing a more optimum air-fuel mixture for better fuel economy, emissions control and engine performance. However, the '811 patent fails to disclose a system that is cost-effective and that provides an optimum air-fuel mixture for the internal combustion engine.

### SUMMARY OF THE DISCLOSURE

In an aspect of the present disclosure, a system for controlling pressure of fuel supplied to an engine is provided. The system includes a pressure sensor configured to generate signals indicative of pressure of fuel at an outlet of a pressure regulator. The system further includes a stepper motor coupled to a gear drive. The gear drive is adapted to transfer rotational movement of a shaft of the stepper motor into linear movement of a plunger of the pressure regulator. The plunger is adapted to move against a biasing force of a biasing member to adjust the preload of the pressure regulator. The system further includes a controller in electric communication with the pressure sensor and the stepper motor. The controller is configured to monitor the pressure of the fuel at the outlet of the pressure regulator based on the signals generated by the pressure sensor. The controller is further configured to determine an average pressure of the fuel at the outlet of the pressure regulator for a predefined cycle. The controller is further configured to compare the determined average pressure of the fuel with a threshold pressure. The controller is further configured to generate an output signal when the determined average pressure of the fuel is beyond the threshold pressure. The controller is further configured to communicate the output signal with the stepper motor to preload the pressure regulator. The controller is further configured to control the pressure of the fuel at the outlet of the pressure regulator based on the preload of the pressure regulator.

Other features and aspects of this disclosure will be apparent from the following description and the accompanying drawings.

### BRIEF DESCRIPTION OF THE DRAWINGS

FIG. 1 is a schematic block diagram of a fuel supply system of an engine;

FIG. 2 is a schematic block diagram of a system used for controlling pressure of fuel supplied to the engine; and

FIG. 3 is a flowchart of a method for controlling pressure of fuel supplied to the engine.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in singular may also be construed to relate to the plural and vice-versa without limiting the scope of the disclosure to the exact number or type of such elements unless set forth explicitly in the appended claim.

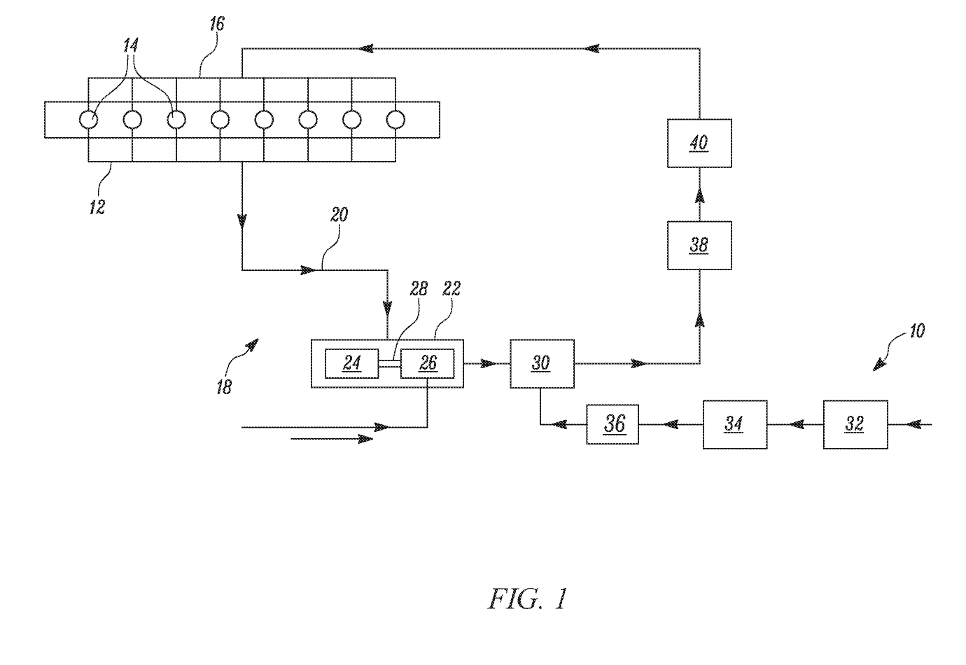

Referring to FIG. 1, a schematic block diagram of a fuel supply system 10 of an engine 12 is illustrated. For the purposes of this disclosure, the engine 12 is depicted and described as a gaseous fuel-powered engine. However, it will be understood by a person skilled in the art that the engine 12 may be any type of combustion engine, such as a diesel engine. The engine 12 is used to provide power to any machine including, but not limited to, an on-highway vehicle, an off-highway vehicle, an earth moving machine, and an electric generator. Further, the engine 12 may be employed in any machine associated with any industry including, but not limited to, transportation, construction, agriculture, forestry, power generation, and material handling.

The engine 12 includes a plurality of cylinders 14, where each cylinder 14 is connected to an inlet manifold 16 for receiving charge, which includes a mixture of fuel and air. An exhaust system 18 of the engine 12 directs exhaust gas from the engine 12 to the atmosphere. Particularly, the exhaust system 18 includes an exhaust manifold 20 in fluid communication with the cylinders 14. The exhaust produced during a combustion process within the cylinders 14 exits the engine 12 via the exhaust manifold 20.

The exhaust system 18 further includes a turbocharger 22 in fluid communication with the exhaust manifold 20. The turbocharger 22 includes a turbine 24 operatively coupled to a compressor 26 via a shaft 28. The turbine 24 is driven by the exhaust gases routed from the engine 12 through the exhaust manifold 20. The compressor 26 receives air from the atmosphere. During operation, the turbine 24 converts kinetic energy of the exhaust gases into mechanical energy to drive the compressor 26 via the shaft 28. Based on a rotational speed of the compressor 26, the received air is compressed to a desired pressure, and thereafter supplied to a mixer 30.

The fuel supply system 10 provides fuel, such as gas, to the engine 12. The fuel supply system 10 includes various components, such as a fuel pump (not shown) and a fuel tank (not shown). The fuel to be supplied to the cylinders 14 of the engine 12 is stored in the fuel tank. The fuel pump pumps the fuel from the fuel tank to the mixer 30 via a gas shutoff valve 32, a pressure regulator 34, and a fuel metering valve 36. The gas shutoff valve 32 selectively allows flow of fuel to the pressure regulator 34. In an example, an Engine Control Module (ECM) of the engine 12 may actuate the gas shutoff valve 32 to selectively allow flow of fuel to the pressure regulator 34. The pressure regulator 34 controls the pressure of the fuel flowing to the fuel metering valve 36. In an example, the fuel may enter the pressure regulator 34 at a first pressure and the fuel may exit the pressure regulator 34 at a second pressure. The fuel metering valve 36 controls a fuel flow rate with respect to the air supplied to the mixer 30. Further, the fuel metering valve 36 maintains either a stoichiometric value of air-fuel ratio or a predetermined value of air-fuel ratio in the mixer 30 by controlling the fuel flow rate based on air flow ate and air pressure. In an example, the ECM of the engine 12 may actuate the fuel metering valve 36 to control the fuel flow rate to the engine 12. The mixer 30 ensures mixing of air and fuel based on a load demand from the engine 12. Upon mixing of the air and the fuel in the mixer 30, the mixture of air-fuel is allowed to flow into a throttle valve 38. The throttle valve 38 controls a flow rate of the mixture of air-fuel based on the load demand from the engine 12. The air-fuel mixture from the throttle valve 38 is then supplied to a charge cooling system 40, which controls temperature of the mixture of air-fuel before being supplied to the cylinders 14 via the inlet manifold 16. The engine 12 includes a system 42 in communication with the pressure regulator 34 for controlling a pressure of the fuel supplied to the engine 12.

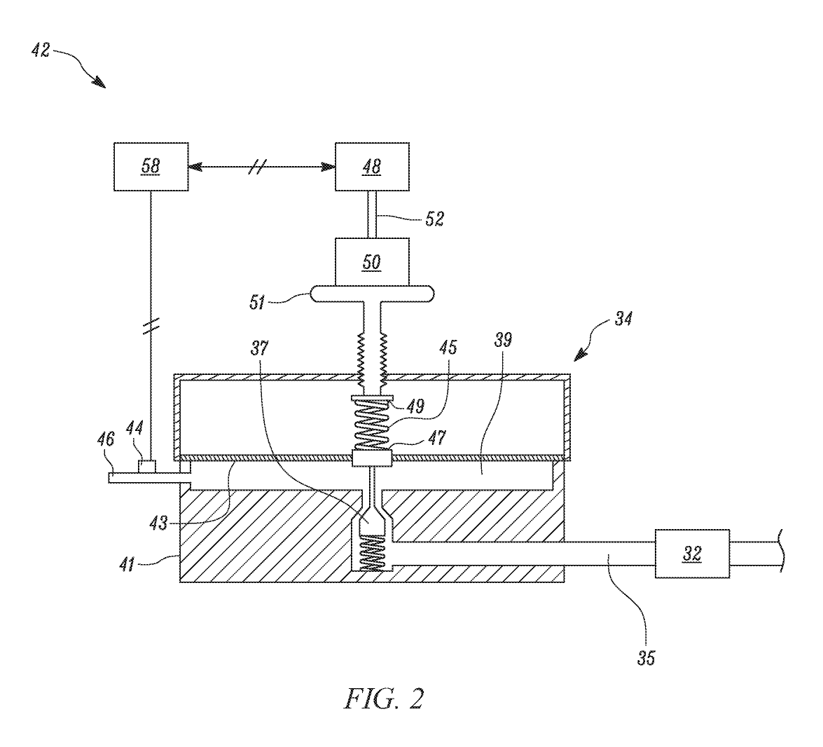

Referring to FIG. 2, a schematic block diagram of the system 42 used for controlling pressure of fuel supplied to the engine 12 is illustrated. The pressure regulator 34 embodied in the present disclosure is an exemplary electronically-controlled mechanical pressure regulator. In other examples, the system 42 may be used for actuating any known mechanical pressure regulators for controlling the pressure of the fuel supplied to the engine 12. The pressure regulator 34 includes a housing 41 that is adapted to enclose a needle valve 37. The housing 41 further encloses a diaphragm 43, which defines a chamber 39 within the housing 41. The needle valve 37 is coupled to the diaphragm 43 and adapted to control flow of fuel from an inlet 35 to the chamber 39 based on deflection of the diaphragm 43. A biasing member 45 having a first end 47 and a second end 49 is disposed on the diaphragm 43. More specifically, the first end 47 of the biasing member 45 is coupled to the diaphragm 43 and the second end 49 of the biasing member 45 is coupled to a plunger 51. The plunger 51 is movably engaged with a wall of the housing 41 and is adapted to preload the pressure regulator 34. Preloading of the pressure regulator 34 is otherwise defined as adjusting a biasing force of the biasing member 45 such that deflection of the diaphragm 43 based on the pressure of the fuel in the chamber 39 may be controlled. The needle valve 37 is movable between a first position and a second position along a flow of the fuel from the inlet 35 to the chamber 39. The needle valve 37, in the first position, allows flow of the fuel into the chamber 39 and in the second position, restricts flow of fuel into the chamber 39. The system 42 includes a pressure sensor 44 adapted to generate signals indicative of the second pressure of the fuel at an outlet 46 of the pressure regulator 34. The outlet 46 is in fluid communication with the chamber 39. In an example, the pressure sensor 44 may be disposed proximal to the outlet 46 of the pressure regulator 34 such that the pressure sensor 44 senses the pressure of the fuel at the outlet 46 during each cycle of operation of the engine 12. For instance, pressure of the fuel at the outlet 46 of the pressure regulator 34 is monitored for every combustion cycle of the engine 12. The system 42 further includes a stepper motor 48 coupled to a gear drive 50. The stepper motor 48 is adapted to preload the pressure regulator 34. The stepper motor 48 includes an output shaft 52 coupled to the gear drive 50 of the system 42. The output shaft 52 transfers rotational movement of the stepper motor 48 to the gear drive 50.

In one implementation, the gear drive 50 is operated based on a rotation of the output shaft 52 of the stepper motor 48. The gear drive 50 may include a worm screw (not shown) and a worm wheel (not shown). The worm wheel may be coupled to the output shaft 52 of the stepper motor 48. The rotational movement generated by the stepper motor 48 is transferred to the gear drive 50 via the worm wheel. The worm wheel is continuously meshed with the worm screw. One end of the worm screw is coupled to the plunger 51. The plunger 51 is adapted to transfer linear movement generated by the gear drive 50 to the biasing member 45. Upon movement of the plunger 51 downward or upward, preload of the biasing member 45 may be increased or decreased, respectively.

The system 42 further includes a controller 58 in electric communication with the pressure sensor 44 and the stepper motor 48. The controller 58 is configured to control the pressure of fuel at the outlet 46 of the pressure regulator 34. In one example, the controller 58 may be integral to the Engine Control Module (ECM) of the engine 12. In another example, the controller 58 may be an individual module communicated with the ECM of the engine 12. In some implementations, the controller 58 may be a processor that includes one or more processing units, all of which include multiple computing units. The processor may be implemented as hardware, software, or a combination of hardware and software capable of executing a software application. In some implementations, the controller 58 may be implemented as one or more microprocessors, microcomputers, digital signal processors, central processing units, state machines, logic circuitries, and/or any device that is capable of manipulating signals based on operational instructions. Among the capabilities mentioned herein, the controller 58 may also be configured to receive, transmit, and execute computer-readable instructions. The controller 58 may be configured to control various systems and sub-assemblies of machines and, thus, may control many aspects of the operations of the machines.

During operation of the engine 12, the pressure sensor 44 senses pressure of the fuel at the outlet 46 of the pressure regulator 34 and generates the signals indicative of the pressure of the fuel. The controller 58 determines pressure of the fuel at the outlet 46 for each cycle of the engine 12. The controller 58 receives the signals from the pressure sensor 44. The controller 58 further determines an average pressure of the fuel for a predefined cycle based on the signal received. For example, the average pressure of the fuel may be calculated for 300 cycles of the engine 12. Further, the controller 58 compares the determined average pressure of the fuel with a threshold pressure. The threshold pressure is understood as a pressure range defined by an upper limit and a lower limit. If the average pressure of the fuel at the outlet 46 is beyond or below the upper limit or the lower limit, respectively, then the controller 58 actuates the stepper motor 48 to preload the pressure regulator 34. Based on the comparison, the controller 58 generates an output signal, when the determined average pressure of the fuel is beyond the threshold pressure.

Based on the generated output signal, the stepper motor 48 is controlled to actuate the gear drive 50 to preload the pressure regulator 34. The output shaft 52 of the stepper motor 48 rotates based on the output signal communicated with the stepper motor 48 by the controller 58. The rotation of the output shaft 52 is further transmitted to the gear drive 50. The gear drive 50 converts the rotational movement of the stepper motor 48 to the linear movement of the plunger 51. Owing to the linear movement of the plunger 51, the biasing force of the biasing member 45 is controlled. In an example, if the gear drive 50 causes a linear movement of the plunger 51 in an upward direction, then the biasing force of the biasing member 45 decreases. Likewise, if the gear drive 50 causes a linear movement of the plunger 51 in a downward direction, then the biasing force of the biasing member 45 increases. Based on the biasing force of the biasing member 45 and the pressure of the fuel at the outlet 46, the diaphragm 43 deflects in upward direction or downward direction to restrict or allow flow of fuel, respectively, into the chamber 39 of the pressure regulator 34.

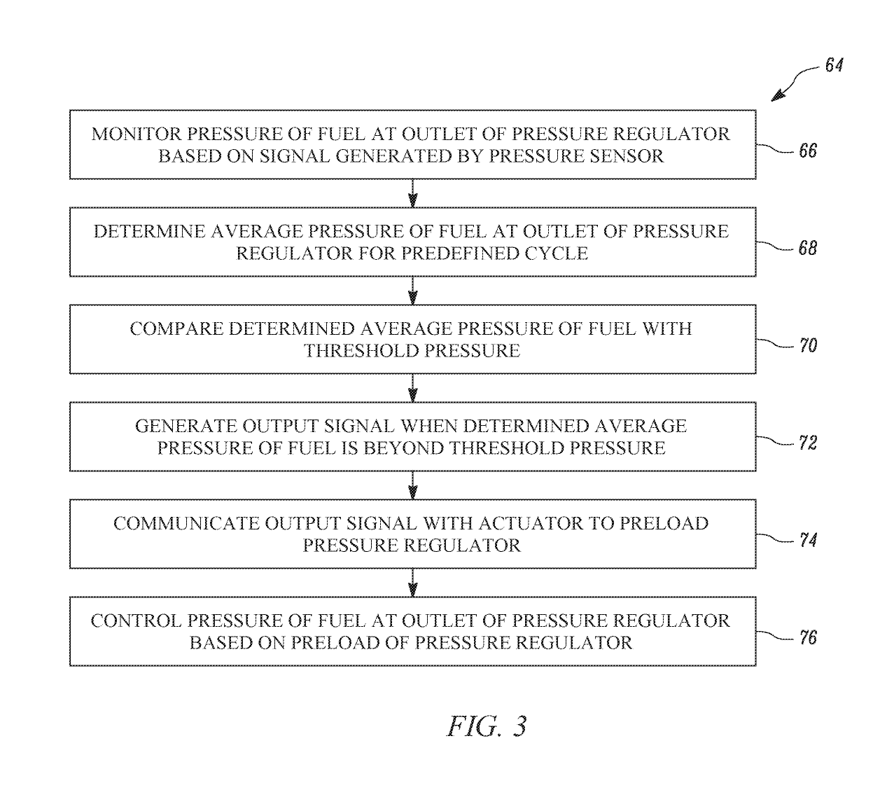

Referring to FIG. 3, a flowchart of a method 64 for controlling pressure of fuel supplied to the engine 12 is illustrated. The steps in which the method 64 is described are not intended to be construed as a limitation, and any number of steps can be combined in any order to implement the method 64. Further, the method 64 may be implemented in any suitable hardware, such that the hardware employed can perform the steps of the method 64 readily and on a real-time basis. The method 64 may be performed by the controller 58. Various steps of the method 64 are described in conjunction with FIG. 2 of the present disclosure. As illustrated, at step 66, the method 64 includes monitoring the pressure of the fuel at the outlet 46 of the pressure regulator 34. In some implementations, the controller 58 receives the pressure of the fuel and monitors the pressure of the fuel based on the signals generated by the pressure sensor 44.

At step 68, the method 64 includes determining the average pressure of the fuel at the outlet 46 of the pressure regulator 34 for the predefined number of cycles In some implementations, the predefined number of cycles may be 300 cycles. Further, at step 70, the method 64 includes comparing the determined average pressure of the fuel with the threshold pressure. In some implementations, the controller 58 compares the determined average pressure of the fuel with the threshold pressure.

At step 72, the method 64 includes generating an output signal when the determined average pressure of the fuel is beyond the threshold pressure. The output signal generated is indicative of the average pressure of the fuel for the predefined number of cycles. At step 74, the method 64 includes communicating the generated output signal with the stepper motor 48 to preload the pressure regulator 34. In some implementations, the controller 58 actuates the stepper motor 48 to preload the pressure regulator 34. At step 76, the method 64 includes controlling the pressure of the fuel at the outlet 46 of the pressure regulator 34 based on the preload of the pressure regulator 34. More specifically, the controller 58 controls the pressure of the fuel at the outlet 46 of the pressure regulator 34 based on the preload of the biasing member 45 of the pressure regulator 34.

### Industrial Applicability

The present disclosure relates to the system 42 for controlling pressure of fuel supplied to the engine 12. The pressure regulator 34 utilizes the stepper motor 48 and the controller 58 of the system 42 to adjust preloading thereof. The pressure regulator 34 is capable of controlling pressure of the fuel at the outlet 46 of the pressure regulator 34, when the engine 12 requires the either stoichiometric mixture of air-fuel or other predetermined air-fuel ratio. Owing to the self-locking mechanism of the worm screw in the gear drive 50, the preload of the biasing member 45 may not change even if the stepper motor 48 is deactivated. The stepper motor 48 is actuated only when the adjustment of biasing forces is needed. The diaphragm 43 is self-balanced when the force generated by the pressure in the chamber 39 is equal to the total force generated by both the biasing member 45 and background pressure. The stepper motor 48 may not be activated to maintain the position of the needle valve 37 during operation. When there is a power loss or failure of the pressure sensor 44, the system 42 can still provide regulated fuel pressure within a fixed range. The pressure regulator 34 of the present disclosure is cost effective. Also, the pressure regulator 34 ensures smooth and efficient operation of the engine 12 The pressure regulator 34 supports any gaseous fuel-powered engine by controlling the pressure of the fuel at the outlet 46 of the pressure regulator 34.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for controlling pressure of fuel supplied to an engine, the system comprising:
a pressure sensor configured to generate signals indicative of pressure of fuel at an outlet of a pressure regulator;
a stepper motor coupled to a gear drive, the gear drive adapted to transfer rotational movement of a shaft of the stepper motor into linear movement of a plunger of the pressure regulator, wherein the plunger is adapted to move against a biasing force of a biasing member to adjust the preload of the pressure regulator; and
a controller in electric communication with the pressure sensor and the stepper motor, the controller configured to:
monitor the pressure of the fuel at the outlet of the pressure regulator based on the signals generated by the pressure sensor;
determine an average pressure of the fuel at the outlet of the pressure regulator for a predefined cycle;
compare the determined average pressure of the fuel with a threshold pressure;
generate an output signal when the determined average pressure of the fuel is beyond the threshold pressure;
communicate the output signal with the stepper motor to adjust the preload of the pressure regulator; and
control the pressure of the fuel at the outlet of the pressure regulator based on the preload of the pressure regulator.

2. The system of claim 1, wherein the gear drive comprises a worm wheel coupled to the stepper motor and a worm engaged with the worm wheel, wherein a linear movement of the worm is transferred to the plunger.
